(19) United States
(12) Patent Application Publication
(10) Pub. No.: US 2026/0162478 A1
(43) Pub. Date: Jun. 11, 2026

(54) SYSTEM FOR DETERMINING AN AUTHENTICATION ZONE FOR AN ELECTRONIC LOCKSET

(71) Applicant: ASSA ABLOY Americas Residential Inc., New Haven, CT (US)

(72) Inventor: Kevin Coleman, Lake Forest, CA (US)

(73) Assignee: ASSA ABLOY Americas Residential Inc., New Haven, CT (US)

(21) Appl. No.: 19/181,102

(22) Filed: Apr. 16, 2025

Related U.S. Application Data
(60) Provisional application No. 63/635,860, filed on Apr. 18, 2024.

(51) Int. Cl. G07C 9/00

(52) U.S. Cl. CPC G07C 9/00309; G07C 2009/00769

(57) ABSTRACT

In general, a system for determining an authentication zone associated with an electronic lockset is disclosed. The lockset may determine to actuate a locking mechanism based in part on whether a user or a user device is located in the authentication zone. Various techniques for determining an authentication zone are disclosed. For example, an authentication zone may be determined based on one or more of a door handing or a door parameter. As another example, an authentication zone may be determined based on a user input. As another example, an authentication zone may be determined based on a detected location of one or more objects external to the electronic lockset.

### CROSS-REFERENCE TO RELATED APPLICATIONS

The present application claims priority from U.S. Provisional Ser. No. 63/635,860, filed on Apr. 18, 2024, the disclosure of which is hereby incorporated by reference in its entirety.

### BACKGROUND

Some electronic locksets may be actuated in response to wirelessly receiving credentials from a user or a device. In some instances, the user's location relative to the lock may be an important consideration in determining whether the user wants to actuate the lock. For example, if the user is on the inside of a premises to which the lockset is attached, the user may not want to actuate the electronic lockset, even though the user or a user device may be in communication range with the electronic lockset. However, it may be challenging for a lockset to determine whether the user is inside of the premises or outside of the premises, given that the dimensions of the premises and the lockset position within these dimensions may vary from one doorway configuration to the next.

### SUMMARY

In general, a system for determining an authentication zone is disclosed. Based on the authentication zone, it may be determined whether an electronic lockset is to be actuated. There are various techniques that may be used to determine an authentication zone. For example, the authentication may be determined based on one or more of a user input, a calculation involving dimensions of a door or a door handing, or a calculation that uses the location of a detected object.

In a first aspect, a system for determining an authentication zone is disclosed. The system includes a processor; and memory storing instructions that, when executed by the processor, cause the system to: determine a handing of a door; determine one or more parameters of the door, the one or more parameters of the door including a length of the door; based at least in part on the handing and the length, determine an authentication zone for an electronic lockset mounted to the door; wherein the authentication zone defines an area from which the electronic lockset is wirelessly actuatable.

In a second aspect, a system for determining an authentication zone is disclosed . The system comprises a processor; and memory storing instructions that, when executed by the processor, cause the system to: display a user interface; receive, via the user interface, an input including data related to a secured area; based on the input, determine an authentication zone for an electronic lockset; wherein the authentication zone defines an area from which the electronic lockset is wirelessly actuatable.

In a third aspect, a system for determining an authentication zone is disclosed. The system includes a processor; and memory storing instructions that, when executed by the processor, cause the system to: determine a location of a wall of a secured area, the location including a distance and direction of the wall relative to an electronic lockset; and based in part on the location of the wall, determining an authentication zone; wherein the authentication zone defines an area from which the electronic lockset is wirelessly actuatable.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 illustrates an environment including an electronic lockset in which aspects of the present disclosure may be implemented.

FIG. 2 illustrates example configurations of secured areas.

FIG. 3 illustrates a side view of a portion of an electronic lockset usable within the environment of FIG. 1.

FIG. 4 illustrates a rear perspective view of a portion of an electronic lock usable within the environment of FIG. 1.

FIG. 5 illustrates a front perspective view of a portion of an electronic lock usable within the environment of FIG. 1.

FIG. 6 illustrates a schematic representation of an electronic lock, in accordance with aspects of the present disclosure.

FIG. 7 illustrates a schematic representation of a mobile device seen in the environment of FIG. 1.

FIG. 8 is a flowchart of an example method for using an authentication zone as part of determining whether to actuate a lock.

FIG. 9 is a flowchart of an example method for determining an authentication zone.

FIG. 10 illustrates example authentication zones of a left-handed door and a right-handed door.

FIG. 11 illustrates example authentication zones for a secured area.

FIG. 12 is a flowchart of an example method for determining an authentication zone.

FIG. 13 illustrates an example user interface for determining an authentication zone.

FIG. 14 illustrates an example user interface for determining an authentication zone.

FIG. 15 illustrates an example user interface for determining an authentication zone.

FIG. 16 is a flowchart of an example method for determining an authentication zone.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

As briefly described above, embodiments of the present invention relate to determining an authentication zone for an electronic lockset. The authentication zone may be an area from which the electronic lockset is wirelessly actuatable. The authentication zone may be an area that is external to a secured area to which the electronic lockset is attached In some embodiments, the electronic lockset may be configured to wirelessly receive credentials from a user device. The electronic lockset may determine a location from which the credentials were sent. On the one hand, if the credentials were sent from a location within the authentication zone, then the electronic lockset may actuate a locking mechanism (e.g., move from a locked to an unlocked state, or vice-versa). On the other hand, if the credentials were sent from a location that is not in the authentication zone, then the electronic lockset may not actuate, even though the credentials may otherwise be associated with an authorized user.

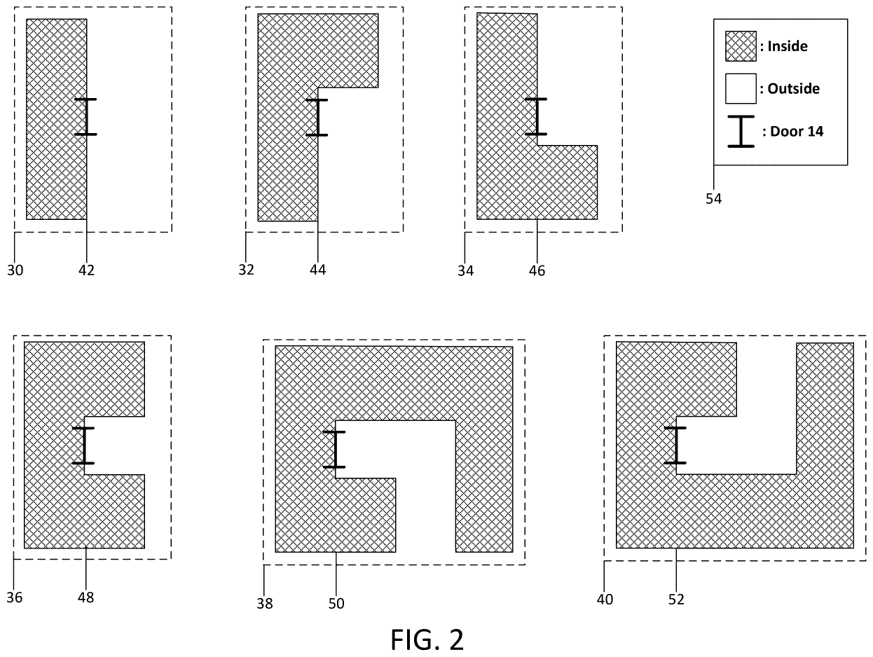

In an example aspect, the electronic lockset may be mounted to a door that is attached to a secured area, such as a building. At a side of the electronic lockset, a wall of the secured area may extend outward relative to the electronic lockset (see, for example, the example configuration 32 of FIG. 2). An authorized user or user device may be positioned in the part of the secured area that extends outward. Without a proper authentication zone, the electronic lockset may incorrectly determine that the user is outside the secured area (e.g., outside of the premises). The electronic lockset may receive credentials from the user device, and the electronic lockset may actuate a locking mechanism (e.g., moving from a locked state to an unlocked state), even though the user is inside of the premises and may not want to actuate the locking mechanism. This unexpected locking behavior may pose a security risk. For example, an intruder may be standing outside of the door, and the user may be inside and looking out the window when the user device inadvertently unlocks the door. As another example, a user may incorrectly assume that the lockset is locked when, in fact, it is unlocked, or vice-versa. By determining an authentication zone, however, this security risk may be reduced, since the authentication zone may correspond to an area that is outside of the premises, thereby ensuring that the lock may not be automatically actuated when the user device is inside.

In an example aspect, various techniques for determining an authentication zone are provided. As one example, an authentication zone may be determined based on a door handing and door parameters, such as a door length. Based on one or more of the door handing and the door parameters, an authentication zone may be calculated. For example, an area in which the door swings may be determined, and it may be inferred that walls of the secured area are not located in the area in which the door swings. It may be assumed, in some instance, that this area is outside of the secured area and therefore part of an authentication zone. Other techniques for determining an authentication zone using door parameters are likewise possible and are further described below.

In an example aspect, an authentication zone may be determined based at least in part on a user input. A user may have a device that is communicatively coupled with the electronic lockset. Based at least in part on data input via the device, the authentication zone may be determined. For example, the user may answer questions related to the authentication zone configuration, the user may select an image that corresponds to an authentication zone configuration, or the user may provide other input that may be used to determine an authentication zone.

In an example aspect, an authentication zone may be determined by using one or more sensors for detecting walls of the secured area. For example, the electronic lockset (or a device communicatively coupled with the electronic lockset) may determine the locations of one or more walls of the secured area that are near the electronic lockset. Such sensors or devices may include, for example, radio frequency sensors, ultrasonic sensors, infrared sensors, a camera, or another type of device or sensor. Based on the detected locations and characteristics of the walls of the secured area, the authentication zone may be determined.

Aspects of the present disclosure provide various technical advantages. For example, an authentication zone may be defined for a lockset that is external to a secured area. By using an authentication zone to determine whether to lock or unlock, the lockset may not inadvertently cause the lockset to lock or unlock when the user is inside of a secured area. As a result, the use of the lockset may better match a user's expectations, while still retaining an ability to actuate the lockset automatically and wirelessly. Furthermore, by reducing inadvertent lock actuation, the security provided by the lockset is improved.

Yet still, techniques described herein for determining an authentication zone may be flexibly applied to different types of secured areas, such as buildings, that may have dimensions or features that vary from one site to the next. Furthermore, according to some aspects of the present disclosure, an authentication zone may be automatically determined, thereby increasing the ease of using or installing the lockset.

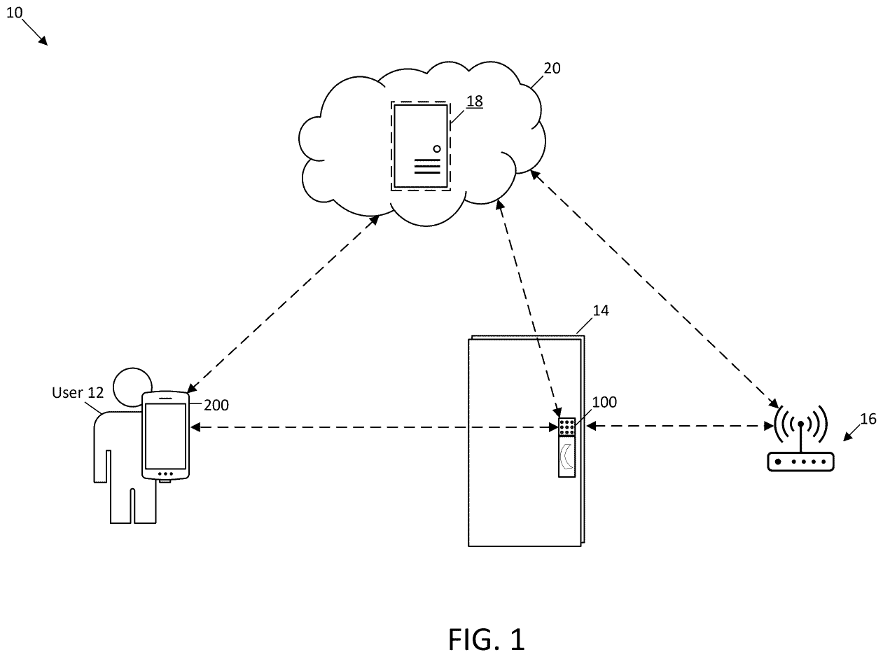

FIG. 1 illustrates an environment 10 in which aspects of the present disclosure may be implemented. The environment 10 includes a user 12, a mobile device 200, a door 14, a lockset 100, a wireless router 16, and a server 18.

The user 12 may interact with the lockset 100 to, for example, install the lockset 100, actuate a locking mechanism, check a status of the lock, update a lock setting, or perform another operation related to the lock. In some instances, the user 12 may be registered with the lockset 100 or may otherwise be authorized to actuate the lockset 100, such as an owner or tenant of the secured area where the door 14 comprising the lockset 100 is installed. In some instances, the user 12 may have a code that he or she may enter at a keypad of the lockset 100 to actuate the locking mechanism, either in addition to or to the exclusion of the user being otherwise registered or authorized at the electronic lock (e.g., via connectivity between a mobile device of the user and the electronic lock).

The door 14 may be an interior or exterior door installed at a secured area. Described below are non-limiting examples of a wireless electronic lockset mounted to the door 14. It should be noted that the lockset 100 may be used on other types of doors, such as a garage door, garden shed door, lockbox door, sliding door, doggie door, or other types of doors that require an authentication process to unlock (or lock) the door.

The lockset 100 may be an electronic lockset that is configured to lock and unlock the door 14. In some embodiments, the lockset 100 may be configured to lock or unlock the door 14 in response to receiving credentials associated with an authorized user. For example, the lockset 100 may receive and verify credentials from the mobile device 200. In some instances, prior to actuating a locking mechanism, the lockset 100 may determine whether a source of the credentials is located within an authentication zone. If it is determined that the source of the credentials is located in the authentication zone, then the lockset 100 may execute an instruction to actuate a locking mechanism. If it is determined that the source of the credentials is not located in the authentication zone, then the lockset 100 may not execute the instruction to actuate the locking mechanism. In some embodiments, the lockset 100 may include wireless communication capabilities. For example, the lockset 100 may include components for communicating with the user 12 and the mobile device 200.

The user 12 may be associated with the mobile device 200. For example, the user 12 may carry the mobile device 200 or be the owner of the mobile device 200. The mobile device 200 may be a device with wireless communication capabilities, such as a smartphone, tablet, or key fob. The mobile device 200 may be capable of communicating with the lockset 100, communicating with the server 18, communicating with other mobile devices, and communicating with the router 16. The mobile device 200 may have a mobile application installed thereon that is associated with the lockset 100 or the server 18. The mobile device 200 may include a web browser for accessing a program to communicate with the lockset 100 or the server 18. The mobile device 200 may include a camera and an application for analyzing images captured by the camera.

The router 16 may be a Wi-Fi router. In some embodiments, the router 16 may be located within the secured area or building to which the door 14 is attached. The router 16 may be capable of communicating with the lockset 100, and the router 16 may be capable of communicating with the server 18. The router 16 may route communications between the server 18 and the lockset 100. In some embodiments, the router may be a hub for Internet of Things (IoT) devices. In some embodiments, the lockset 100 and the router 16 may be coupled via a mesh network. For instance, communication between the lockset 100 and the router 16 may be passed through one or more other devices.

The server 18 can be, for example, a physical server or a virtual server hosted on a cloud platform 20. In examples, the cloud platform 20 may be a multi-cloud platform, a private cloud, a public cloud, or a hybrid cloud. In some embodiments, the server 18 may include a cluster of servers or nodes. In some embodiments, the lockset 100 is also capable of communicating with the server 18. Such communication can optionally occur via one or more wireless communication protocols, e.g., Wi-Fi (IEEE 802.11), short-range wireless communication to a Wi-Fi bridge, or other connection mechanism. According to an embodiment, the server 18 may create and store an account associated with one or more of the lockset 100, the user 12, the mobile device 200, the router 16, the door 14, or a building on which the door 14 is installed. In some embodiments, the server 18 may create or store credentials for one or more of the accounts.

FIG. 2 illustrates example configurations 30-40 of the door 14 and example premises 42-52 to which the door 14 may be attached. The premises 42-52 are examples of secured areas. The premises 42-52 may be, for example, a building, a fenced or otherwise enclosed area, a temporary structure, a geofenced area, or another geographical area. In the example of FIG. 2, a key 54 indicates that an inside of a premises of the premises 42-52 is marked using intersecting diagonal lines.

The inside of a premises may include an area that is enclosed by walls of a premises. Although not illustrated, an inside may include multiple levels (e.g., a basement, a first floor, and a second floor), and dimensions of each level may vary. In some embodiments, an inside of a premises may be defined using multiple areas, such as a building and an adjacent enclosed area, such as a garage, porch, or enclosed area. In some embodiments, the inside of a premises may only be partially defined (e.g., only walls nearby the door 14 may be considered). As is further indicated by the key 54, an outside of a premises of the premises 42-52 is marked by blank space. The outside of a premises of the premises 42-52 may include an area that is not part of the inside of a premises. In some embodiments, the outside may include an area in which a user may approach the door 14 from the outside. In some embodiments, an authentication zone associated with the lockset 100 may include an area that is outside of a premises and may not include an area that is inside of the premises.

As shown, in each of the example configurations 30-40, the dimensions of the respective premises of the premises 42-52 may vary. For example, in the configuration 30, a straight line may separate the inside of the premises 42 from the outside of the premises. In the example configuration 30, the lockset 100 attached to the door 14 may define an authentication zone that includes only an area outside of the premises 42 by using a 180-degree angle that extends outward from the lockset 100.

For the lockset 100 in the configurations 32-40, however, a different authentication zone may have to be determined, because a 180-degree angle that extends outward may include an area that is inside of the premises 42-52, which may, in some instances, cause the lockset 100 to actuate a locking mechanism without a user intending to do so. For example, referring to the example configuration 32, a user may be located inside of the premises 44 (e.g., in the part at the top of the premises 44 that extends outward), but if it is assumed that the inside and outside of the premises 44 may be separated by a single straight line (e.g., as is the case in the example configuration 30), then the lockset 100 may incorrectly determine that the user is outside of the premises 44. Similar issues may arise in connection with the example configurations 34-40.

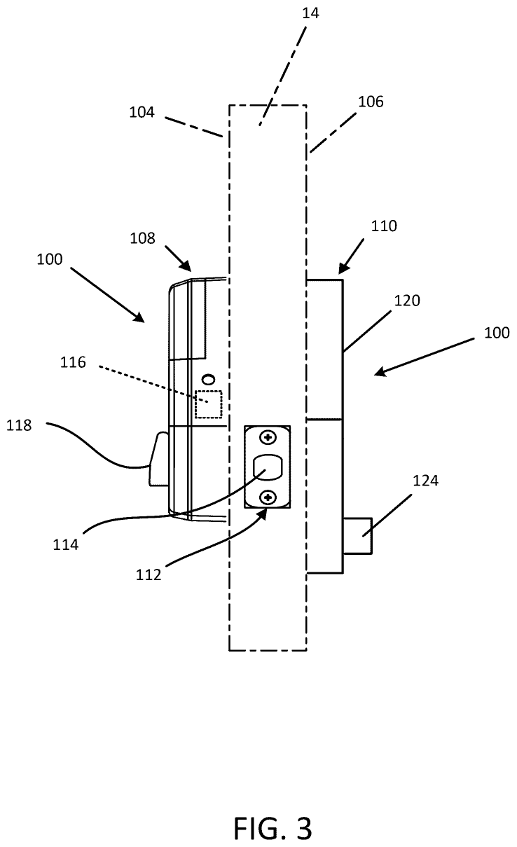

FIG. 3 illustrate a lockset 100 as installed at a door 14, according to one example of the present disclosure. The door 14 has an interior side 104 and an exterior side 106. The lockset 100 includes an interior assembly 108, an exterior assembly 110, and a latch assembly 112. To move the lockset 100 from a locked state to an unlocked state, or from an unlocked state to a locked state, the lockset 100 may actuate the latch assembly 112. The latch assembly 112 is shown to include a bolt 114 that is movable between an extended position (locked) and a retracted position (unlocked, shown in FIGS. 3-6). Specifically, the bolt 114 is configured to slide longitudinally and, when the bolt 114 is retracted, the door 14 is in an unlocked state. When the bolt 114 is extended, the bolt 114 protrudes from the door 14 into a doorjamb to place the door in a locked state. In examples, a processor of the lockset 100 may use a motor to actuate the bolt 114.

In some examples, the interior assembly 108 is mounted to the interior side 104 of the door 14, and the exterior assembly 110 is mounted to the exterior side 106 of the door 14. The latch assembly 112 is typically at least partially mounted in a bore formed in the door 14. The term outside is broadly used to mean an area outside the door 14, and the term inside is broadly used to denote an area inside the door 14, as described above in connection with FIG. 2. With an exterior entry door, for example, the exterior assembly 110 may be mounted outside a building, while the interior assembly 108 may be mounted inside a building. With an interior door, the exterior assembly 110 may be mounted inside a building, but outside a room secured by the lockset 100, and the interior assembly 108 may be mounted inside the secured room. The lockset 100 is applicable to both interior and exterior doors.

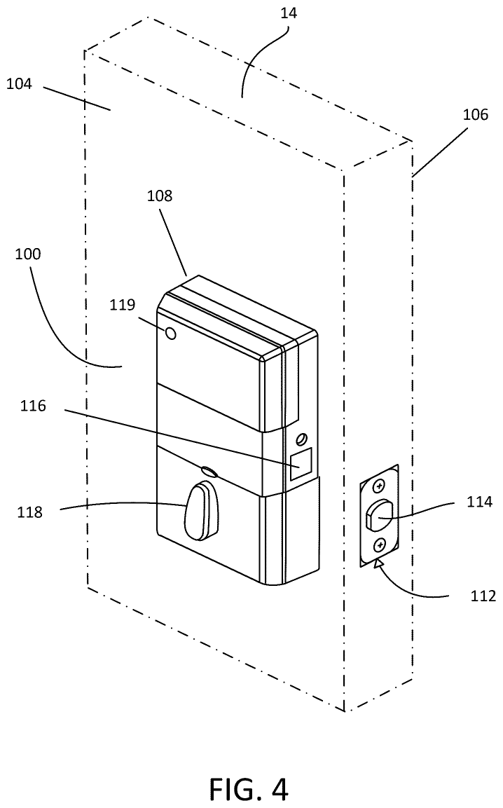

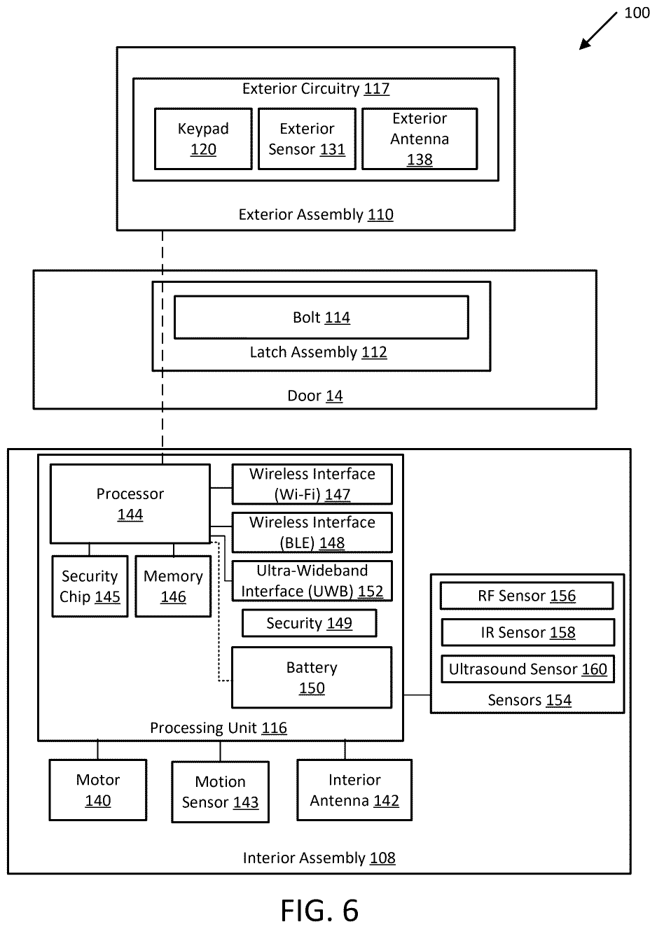

FIG. 4 illustrates a perspective view of the lockset 100 from an interior of the door 14. In some embodiments, the interior assembly 108 can include a processing unit 116 (shown schematically in FIG. 6) containing electronic circuitry for the lockset 100. In some examples, the interior assembly 108 includes a manual turn piece 118 that can be used on the interior side 104 of door 14 to move the bolt 114 between the extended and retracted positions. The processing unit 116 is operable to execute a plurality of software instructions (e.g., firmware) that, when executed by the processing unit 116, cause the lockset 100 to implement the methods and otherwise operate and have functionality as described herein. The processing unit 116 may comprise a device commonly referred to as a processor, e.g., a central processing unit (CPU), digital signal processor (DSP), or other similar device, and may be embodied as a standalone unit or as a device shared with components of the lockset 100. The processing unit 116 may include memory communicatively interfaced to the processor for storing the software instructions. Alternatively, the lockset 100 may further comprise a separate memory device for storing the software instructions that is electrically connected to the processing unit 116 for the bi-directional communication of the instructions, data, and signals therebetween.

In some examples, the interior assembly 108 includes a pairing button 119 (shown schematically), which when actuated, initiates a pairing mode for a connection over an interface. For example, the pairing mode may enable the lockset 100 to communicate with a mobile device (e.g., the mobile device 200) within wireless communication range for enabling the mobile device to be paired with the lockset 100. In some embodiments, once the lockset 100 is paired with the mobile device, the mobile device may be used as part of installing the lockset 100 or as part of determining an authentication zone associated with the lockset 100. In other embodiments, the mobile device 200 need not be paired with the lockset 100 to execute aspects of an installation process for the lockset 100. As can be appreciated, initiating the pairing mode via an actuation of the pairing button 119 may be limited to users who have access to the interior side 104 of the door 14. In some embodiments, the lockset 100 may be coupled with a mobile device without use of the pairing button 119. For instance, pairing may be performed by communicating with the server 18, or one or more of the mobile device 200 or the lockset 100 may broadcast a signal for pairing.

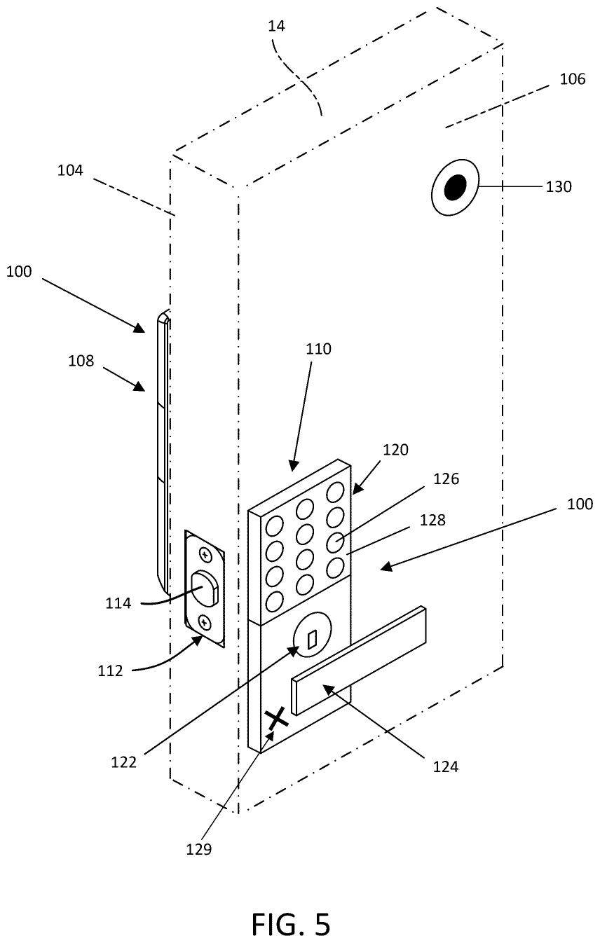

FIG. 5 illustrates a perspective view of the lockset 100 from an exterior of the door 14. The exterior assembly 110 can include exterior circuitry 117 communicatively and electrically connected to the processing unit 116. For example, the exterior assembly 110 can include a keypad 120 for receiving a user input and/or a keyway 122 for receiving a key. The exterior side 106 of the door 14 can also include a handle 124. In some examples, the exterior assembly 110 includes the keypad 120 and not the keyway 122. In some examples, the exterior assembly 110 includes the keyway 122 and not the keypad 120. In some examples, the exterior assembly 110 includes the keyway 122 and the keypad 120. In some examples, the exterior assembly 110 includes neither the keyway 122 nor the keypad 120. When a valid key is inserted into the keyway 122, the valid key can move the bolt 114 between the extended and retracted positions.

When a user inputs a valid actuation passcode into the keypad 120, the bolt 114 may be moved between the extended and retracted positions. In some examples, the exterior assembly 110 is electrically connected to the interior assembly 108. Specifically, in some examples, the keypad 120 may be electrically connected to the interior assembly 108, specifically to the processing unit 116, by, for example, an electrical cable (not shown) that passes through the door 14. When the user inputs a valid actuation passcode via the keypad 120 that is recognized by the processing unit 116, an electrical motor is energized to retract the bolt 114 of latch assembly 112, thus permitting door 14 to be opened from a closed position. In some embodiments, the lockset 100 may be wirelessly actuated without using the keypad 120. For example, the lockset 100 may wirelessly receive an actuation command from the user 12 or the mobile device 200. The actuation command may be accompanied by credentials that may be authenticated by the lockset 100 prior to locking or unlocking. In some embodiments, the lockset 100 may implement a plurality of authentication techniques. For example, the lockset 100 may require a code to be input at the keypad 120 and may require credentials authorizing a user from the mobile device 200. Still further, an electrical connection between the exterior assembly 110 and the interior assembly 108 allows the processing unit 116 to communicate with other features included in the exterior assembly 110, as noted below.

The keypad 120 can be any of a variety of different types of keypads. The keypad 120 can be one of a numeric keypad, an alpha keypad, and/or an alphanumeric keypad. The keypad 120 can have a plurality of characters displayed thereon. For example, the keypad 120 can include a plurality of buttons 126 that can be mechanically actuated by the user (e.g., physically pressed).

In some examples, the keypad 120 includes a touch interface 128, such as a touch screen or a touch keypad, for receiving a user input. The touch interface 128 is configured to detect a user's “press of a button” by contact without the need for pressure or mechanical actuation. In some embodiments, interacting with the keypad 120 may cause an electrical component of the lockset 100 to be activated (e.g., may cause a switch to close), which may allow the user to actuate the bolt 114 using the keypad 120.

In alternative embodiments, one or more other types of user interface devices can be incorporated into the lockset 100. For example, in example implementations, the exterior assembly 110 can include a biometric interface (e.g., a fingerprint sensor, retina scanner, or camera including facial recognition), or an audio interface by which voice recognition could be used to actuate the lock. Still further, other touch interfaces may be implemented, e.g., where a single touch may be used to actuate the lock rather than requiring entry of a specified actuation passcode.

In some embodiments, the lockset 100 may be coupled to a camera 130. In some embodiments, the camera 130 may be disposed on the exterior side 106 of the door 14. In some embodiments, the camera 130 may be activated by a processing unit of the lockset 100. In some embodiments, the camera 130 may detect movement (e.g., a user approaching the door 14). In response to detecting movement, the camera 130 may provide a signal to the lockset 100, thereby activating or deactivating a component of the lockset 100. In some embodiments, the camera 130 may determine or verify whether an authorized user is in an authentication zone associated with the lockset 100.

In some embodiments, indicia 129 may be displayed on the exterior assembly 110. The indicia 129 may be a mark that may be used by an image processing application to identify a location of the lockset 100. For example, an image processing application may be trained to recognize the indicia 129. Thus, when the image analysis program analyzes an image of the lockset 100, the program may recognize the indicia 129 and thereby recognize, in some embodiments, a location of the lockset 100 on the door 14. The indicia 129 may be any marking. In the example shown, the indicia 129 is an “X”. However, the indicia 129 may be a logo, a word, a color, a stamp, a barcode, a QR code, or another mark or feature on the lockset 100. In some embodiments (e.g., when the indicia 129 is a barcode, a QR code, or an alphanumeric string), the image processing application may determine an identifier associated with the lockset 100 by using the indicia 129. In some embodiments, the indicia 129 may be on the interior assembly 108 instead of or in addition to the exterior assembly 110. In some embodiments, the indicia 129 may be located on the door 14 or near the door 14 without being on the lockset 100. In some embodiments, an image processing application may determine a location of the lockset 100 by using other features of the lockset 100 instead of or in addition to the indicia 129.

FIG. 6 illustrates a schematic representation of an embodiment of the lockset 100 mounted to the door 14. Examples of the interior assembly 108, the exterior assembly 110, and the latch assembly 112 are shown. In other embodiments, the lockset 100 may include more or fewer components than those illustrated in connection with the FIG. 6. In some embodiments, the lockset 100 may include an electrical circuit that connects one or more components of the lockset 100 described herein. In examples, the electrical circuit may receive power from a battery 150 or from a different power source. In some embodiments, the lockset 100 may include a plurality of subcircuits, each of which may include one or more components of the lockset 100 described herein, and the subcircuits may, in some embodiments, allow the lockset 100 to selectively activate or deactivate only some electrical components.

The exterior assembly 110 is shown to include the keypad 120 and an exterior antenna 138 usable for communication with a remote device. In addition, the exterior assembly 110 can include one or more sensors 131, such as a camera, proximity sensor, button, or other mechanism by which conditions exterior to the door 14 can be sensed. In some embodiments, the exterior antenna 138 (or an interior antenna 142) may include a plurality of antennas that may be configured to detect a distance and direction of an object external to the lockset 100, such as a user. For example, the lockset 100 may implement angle-of-arrival or angle-of-departure techniques to determine a location of an external object relative to the lockset 100. In response to such sensed conditions (e.g., a detection of an object external to the lockset 100), notifications may be sent by the lockset 100 to a server 18 or mobile device 200, including information associated with a sensed event (e.g., time and description of the sensed event, or remote feed of sensor data obtained via the sensor).

As described above, the latch assembly 112 may include the bolt 114. To extend and retract the bolt 114, the latch assembly 112 may include a drive shaft that is operationally coupled with a motor 140 and the bolt 114. In some embodiments, the drive shaft may rotate in a first direction to extend the bolt and a second direction to retract the bolt.

As described above, the interior assembly 108 includes the processing unit 116. The interior assembly 108 can also include a motor 140, a motion sensor 143, and an interior antenna 142. As shown, the processing unit 116 includes at least one processor 144 communicatively connected to a security chip 145, a memory 146, various wireless network interfaces, and a battery 150. For example, the processing unit 116 may include a network interface for communicating via the IEEE 802.11 standard (Wi-Fi®), the IEEE 802.15.4 standard (Zigbee®, Z-Wave®, and Thread), the IEEE 802.15.1 standard (Bluetooth®), or another standard. In some embodiments the Bluetooth interface 148 may be configured to communicate via a Bluetooth Low Energy (BLE) protocol. In some embodiments, the ultra-wide band (UWB) interface 152 may be configured via a UWB protocol. In some embodiments, a network interface for communicating via other communication protocols may be present, either instead of, or in addition to, the Wi-Fi interface 147, the BLE interface 148, and the UWB interface 152. For example, the electronic lockset 100 may include a network interface for communicating according to one or more of the following protocols: Thread, Matter, near-field communication (NFC), Z-Wave, ZigBee, Narrow Band IoT (NB-IoT), LoRa, 3G, LTE, 4G, 5G or another protocol or network. The processing unit 116 is located within the interior assembly 108 and is capable of operating the lockset 100, e.g., by actuating the motor 140 to actuate the bolt 114.

In some examples, the processor 144 can process signals received from a variety of devices to determine whether the lockset 100 should be actuated. Such processing can be based on a set of preprogramed instructions (i.e., firmware) stored in the memory 146. In certain embodiments, the processing unit 116 can include a plurality of processors 144, including one or more general purpose or specific purpose instruction processors. In some examples, the processing unit 116 is configured to capture a keypad input event from a user and store the keypad input event in the memory 146. In other examples, the processor 144 receives a signal from the exterior antenna 138, the interior antenna 142, or a motion sensor 143 (e.g., a vibration sensor, gyroscope, accelerometer, motion/position sensor, or combination thereof) and can validate received signals in order to actuate the lockset 100. Furthermore, in some examples, the processor 144 may determine whether a location from which the received signals were sent, and the processor 144 may determine whether this location is in an authentication zone prior to actuating the lockset 100. In still other examples, the processor 144 receives signals from one or more network interfaces to determine whether to actuate the lockset 100.

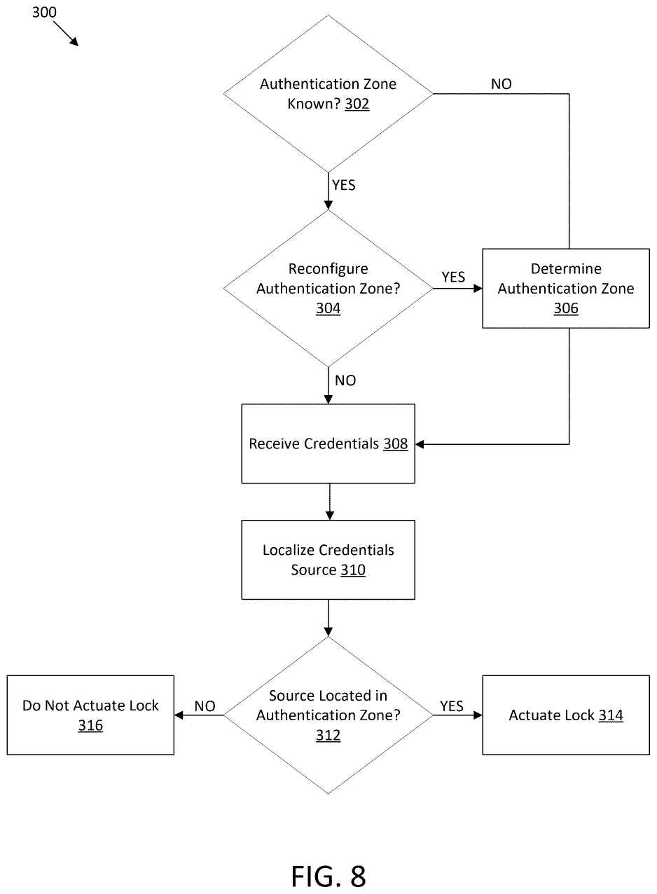

In some embodiments, the processing unit 116 may be configured to execute instructions to define an authentication zone. Example operations for defining an authentication are described below in connection with FIGS. 8-16. The processing unit 116 may be communicatively coupled with sensors 154. In some embodiments, the processing unit 116 may determine an authentication zone associated with the lockset 100 based at least in part on data captured by one or more of the sensors 154. For example, one or more of the sensors 154 may detect a location of an object external to the lockset 100. Based on such data from one or more of the sensors 154, the processing unit 116 may determine an authentication zone. In the example of FIG. 6, the one or more sensors 154 include a radio frequency sensor 156, an infrared sensor 158, and an ultrasound sensor 160. Depending on the embodiment, the one or more sensors 154 may include more or fewer sensors than those illustrated in FIG. 6.

In some embodiments, the processing unit 116 includes a security chip 145 that is communicatively interconnected with one or more instances of processor 144. The security chip 145 can, for example, generate and store cryptographic information usable to generate a certificate usable to validate the lockset 100 with a remote system, such as the server 18 or mobile device (e.g., the mobile device 200). In certain embodiments, the security chip 145 includes a one-time write function in which a portion of memory of the security chip 145 can be written only once, and then locked. Such memory can be used, for example, to store cryptographic information derived from characteristics of the lockset 100, or its communication channels with server 18 or one or more mobile devices 200. Accordingly, once written, such cryptographic information can be used in a certificate generation process which ensures that, if any of the characteristics reflected in the cryptographic information are changed, the certificate that is generated by the security chip 145 would become invalid, and thereby render the lockset 100 unable to perform various functions, such as communicate with the server 18 or mobile device 200, or operate at all, in some cases.

In some embodiments, the security chip 145 may be configured to generate a pairing passcode that, when entered using the keypad 120 of the lockset 100, triggers a pairing mode of one or more of the network interfaces of the lockset 100 that enables the lockset 100 to pair with a proximate mobile device. In some embodiments, a pairing passcode may be used to pair with a proximate mobile device. In some examples, the pairing passcode is provided to the user 12 upon initial setup/activation of the lockset 100 (e.g., via an electronic lock application associated with the lockset 100 operating on the mobile device 200). In some examples, the pairing passcode is a random value. In some examples, the user 12 may be enabled to change the pairing passcode by setting their own code or by requesting a random value to be generated by the electronic lock application operating on the mobile device 200. In some examples, the length of the pairing passcode is variable. According to an aspect, for increased security, the pairing passcode may be a limited-use passcode. For example, the pairing passcode may be limited to a single use or may be active for a preset or administrative user-selected time duration. In further examples, a digit of the pairing passcode may correspond to a setting that may instruct the lockset 100 to perform one or more of: disable the pairing passcode after it has been used; keep the pairing passcode enabled after it has been used; or reset the pairing passcode to a new random value after it has been used.

The memory 146 can include any of a variety of memory devices, such as using various types of computer-readable or computer storage media. A computer storage medium or computer-readable medium may be any medium that can store a program or instructions for performing one or more operations, steps, or methods described herein. By way of example, computer storage media may include dynamic random access memory (DRAM) or variants thereof, solid state memory, read-only memory (ROM), electrically erasable programmable ROM, and other types of devices and/or articles of manufacture that store data. Computer storage media generally includes at least one or more tangible media or devices.

Computer storage media can, in some examples, include embodiments including entirely non-transitory components. In some embodiments, the processor 144 may execute programs or instructions stored by the memory 146. In some embodiments, the memory 146 may store one or more codes that may be input by a user to actuate the bolt 114. For instance, a user may input a code into the keypad 120, or the mobile device 200 may provide a code to the lockset 100 via a network interface. To validate the code, the processor 144 may compare the input code to the one or more codes stored in the memory 146. In some embodiments, the memory 146 may store data that indicates a handing of the door 14, or the memory 146 may store data that indicates that the handing for the door 14 has not yet been determined. In some embodiments, the processor 144 may use the data indicating a handing of the door 14 as part of actuating the motor 140 to control movement of the bolt 114.

As noted above, the processing unit 116 can include one or more wireless interfaces, such as Wi-Fi interface 147, a Bluetooth interface 148, a UWB interface 152, and/or another interface. Other RF circuits can be included as well. In the example shown, the interfaces 147, 148, and 152 are capable of communication using at least one wireless communication protocol. In some examples, the processing unit 116 can communicate with a remote device, such as the server 18, via a first network interface (e.g., the Wi-Fi interface 147) and with a proximate device, such as the mobile device 200, via a second network interface (e.g., the interface 148 or the interface 152). In some embodiments, the processing unit 116 is configured to communicate with the mobile device 200 via a short-range wireless interface, such as a network interface configured to communicate using a protocol for any one or more of BLE, NFC, UWB, Thread, or another protocol. When the mobile device 200 is out of range of such a network, the mobile device 200 may communicate with the server 18, which may relay communications to the lockset 100. In some embodiments, the lockset 100 may use the Wi-Fi interface 147 to communicate with the server 18. In other embodiments, the lockset 100 may communicate with a hub device or router device using a different network protocol (e.g., BLE, NFC, Thread), and the hub device or router may route communications between the server 18 and the lockset 100.

The interior assembly 108 also includes the battery 150 to power the lockset 100. In some embodiments, the lockset 100 may include a plurality of batteries, or the lockset 100 may also include other power sources. In one example, the battery 150 may be a standard single-use (disposable) battery.

The interior assembly 108 also includes the motor 140 that is capable of actuating the bolt 114. In use, the motor 140 receives an actuation command from the processing unit 116, which causes the motor 140 to actuate the bolt 114 from the locked position to the unlocked position or from the unlocked position to the locked position. In some examples, the motor 140 actuates the bolt 114 to an opposing state. In some examples, the motor 140 receives a specified lock or unlock command, where the motor 140 only actuates the bolt 114 if the bolt 114 is in the correct position. For example, if the door 14 is locked and the motor 140 receives a lock command, then no action is taken. If the door 14 is locked and the motor 140 receives an unlock command, then the motor 140 actuates the bolt 114 to unlock the door 14. In some embodiments, the processing unit 116 will actuate the motor 140 in response to wirelessly receiving user credentials and an instruction to actuate the bolt 114. In some embodiments, the processing unit 116 may determine whether a source of the wireless credentials is located in an authentication zone prior to actuating the motor 140. In some embodiments, the operation of the motor 140 to actuate the bolt 114 may depend at least in part on the handing of the door 14. In some embodiments, a mechanism other than the motor 140 may be used to electrically actuate the bolt 114, such as magnets or solenoids.

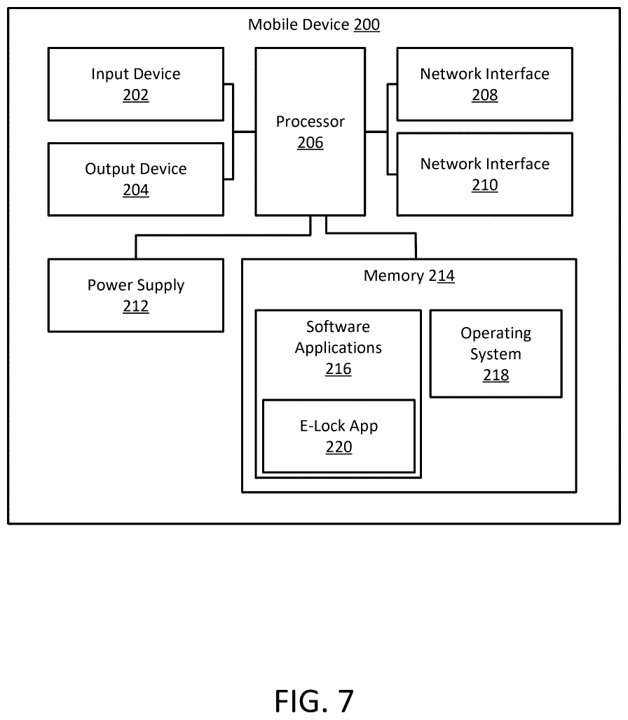

FIG. 7 illustrates a schematic diagram of a mobile device, such as the mobile device 200, usable in embodiments of the present disclosure. In some embodiments, the mobile device 200 operates to form a connection with a network-enabled security device such as the lockset 100. In some embodiments, the mobile device 200 may communicate with the server 18 via a Wi-Fi or mobile data connection. Thus, in some embodiments, the mobile device 200 can operate to communicate information between the lockset 100 and the server 18. The mobile device 200 shown in FIG. 7 includes an input device 202, an output device 204, a processor 206, a first network interface 208, a second network interface 210, a power supply 212, and a memory 214. In some embodiments, the mobile device 200 may include more or fewer network interfaces than two network interfaces. In some embodiments, the first network interface 208 may be a Wi-Fi interface, and the second network interface 210 may include one or more of a Bluetooth interface or a UWB interface. In some embodiments, the mobile device 200 may include an interface to communicate via a cellular network, a Thread protocol, near-field communication protocol, or another protocol or network type.

The input device 202 operates to receive input from external sources. Such sources can include inputs received from a user (e.g., the user 12). The inputs can be received through a touchscreen, a stylus, or keyboard. In some embodiments, the input device may be a microphone, and the mobile device 200 may receive a voice input. In some embodiments, the input device is a camera, and the mobile device may receive an image input or a video input via the camera.

The output device 204 operates to provide output of information from the mobile device 200. For example, a display can output visual information while a speaker can output audio information.

The processor 206 reads data and instructions. The data and instructions can be stored locally, received from an external source, or accessed from removable media. In some examples, the first network interface 208 is similar to the Wi-Fi interface 147. In some embodiments, a Wi-Fi connection may be established between the mobile deice 200 and the server 18. In some embodiments, a connection via a cellular network may be established between the mobile device 200 and the server 18. In some embodiments, the second network interface 210 is similar to the Bluetooth interface 148. In some examples, a Bluetooth connection may be established between the mobile device 200 and the lockset 100. In some embodiments, the second network interface 210 is similar to the UWB interface 152. In some examples, a UWB may be established between the mobile device 200 and the lockset 100. In some embodiments, a connection according to an NFC protocol, Thread protocol, or other protocol may be established between the mobile device 200 and the lockset 100.

The power supply 212 provides power to the processor 206. The memory 214 includes software applications 216 and an operating system 218. The memory 214 contains data and instructions that are usable by the processor to implement various functions of the mobile device 200. Furthermore, the memory 214 may store credentials (e.g., a code or other alphanumeric data) that is associated with the user 12 or the mobile device 200. The mobile device 200 may provide the credentials to the lockset 100 in response to a user input or in response to receiving a communication from the lockset 100. In some embodiments, the mobile device 200 may automatically provide the credentials to the lockset 100 in response to entering a communication range of the lockset 100 (e.g., in response to being within range to communicate with the lockset 100 over BLE or UWB).

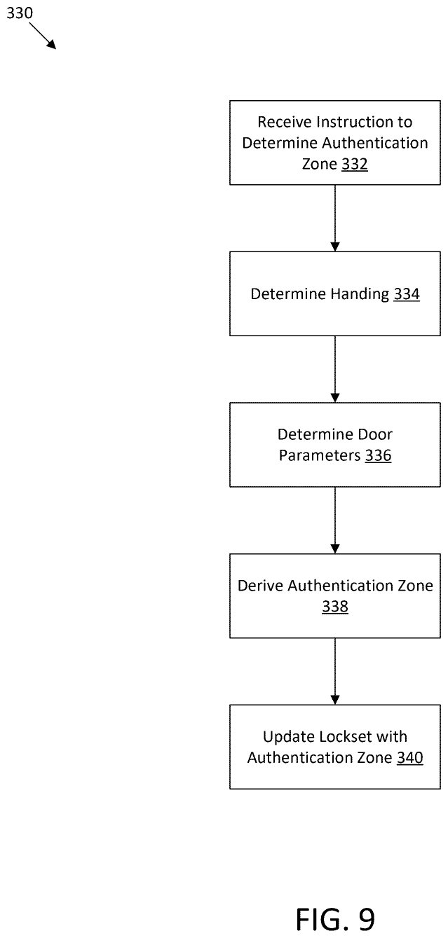

The software applications 216 can include applications usable to perform various functions on the mobile device 200. One such application is an electronic lock application 220. In some embodiments, the electronic lock application 220 may be used to interact with the lockset 100. In some embodiments, the electronic lock application 220 may be used to interact with the server 18. In some embodiments, the electronic lock application 220 may be used as part of installing the lockset 100. In some embodiments, the electronic lock application 220 may be used to determine an authentication zone associated with the lockset 100. In some embodiments, the electronic lock application 220 includes an image processing application that may analyze an image to determine an authentication zone associated with the lockset 100. In other embodiments, the mobile device 200 may include more or fewer components than those illustrated in the example of FIG. 9.

FIG. 8 is a flowchart of an example method 300 for determining whether to actuate a lock. As described herein, operations of the method 300 are performed by the lockset 100. However, one or more operations of the method 300 may be performed by one or more other components, such as the server 18 or the mobile device 200.

In the example shown, the lockset 100 may determine whether an authentication zone is known (step 302). In some embodiments, the lockset 100 may not be pre-configured with a fixed authentication zone. Furthermore, the authentication zone associated with the lockset 100 may depend, for example, on the characteristics (e.g., dimensions) of the premises to which the lockset 100 is attached. When an authentication zone for a lockset 100 has been determined, such data may be stored in a memory of the lockset 100. However, if the authentication zone for the lockset 100 has not been determined (e.g., following an installation of the lockset 100 or following a reset of one or more lock parameters), then the authentication zone may not be known. In response to determining that the authentication zone is not known (e.g., taking the “NO” branch), the lockset 100 may proceed to determine an authentication zone. In response to determining that the authentication zone is known (e.g., taking the “YES” branch), the lockset 100 may proceed to the step 304.

In the example shown, the lockset 100 may determine whether to reconfigure an authentication zone (step 304). For example, an authentication zone may have been previously determined for the lockset 100. However, in response to an instruction to reconfigure the authentication zone (e.g., taking the “YES” branch), the lockset 100 may proceed to determine an updated authentication zone. The instruction to reconfigure the authentication zone may be sent by the server 18 or mobile device 200 (e.g., following a user selection to update the authentication zone), may be generated in response to a selection of a button on the lockset 100, or may be generated in response to a determination that the authentication zone for the lockset 100 is misaligned.

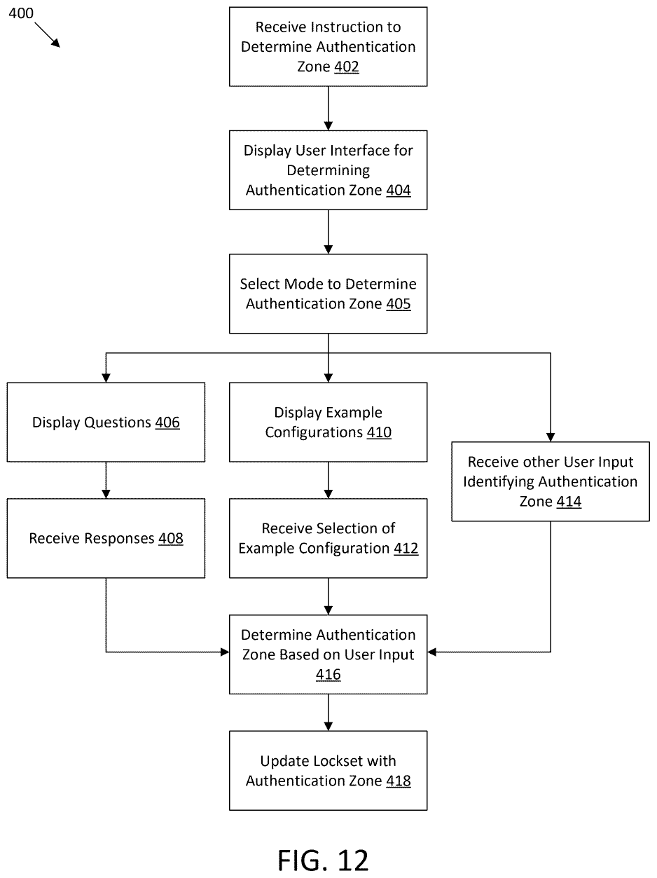

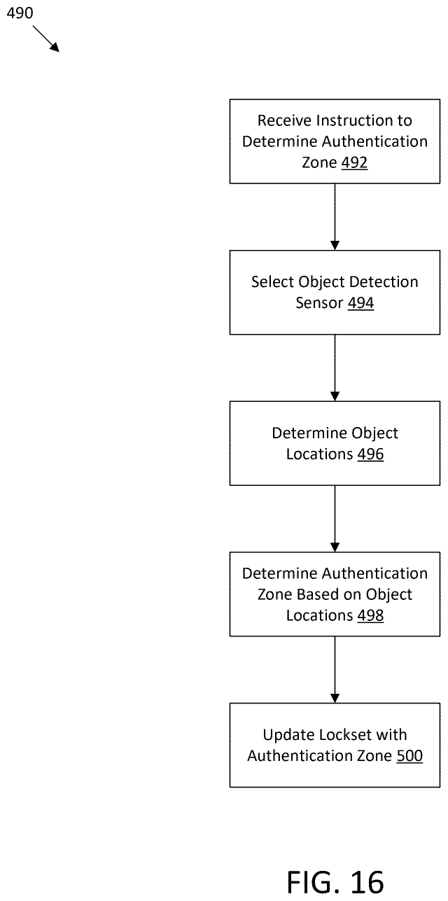

In the example shown, the lockset 100 may determine an authentication zone (step 306). Depending on the embodiment, there may be various techniques that may be used to determine an authentication zone. For example, the lockset 100 may determine an authentication zone based in part on door handing and door parameters, as described below in connection with FIGS. 9-11. As another example, the lockset 100 may determine an authentication zone based in part on a user input, as described below in connection with FIGS. 12-15. As another example, the lockset 100 may determine an authentication zone based in part on a detection of walls or other objects external to the lockset 100, as described below in connection with FIG. 16.

Other techniques are likewise possible for determining an authentication zone, including combinations of aspects of techniques described herein for determining an authentication zone. In some embodiments, a plurality of techniques may be used to determine an authentication zone and to verify an authentication zone. In some embodiments, the authentication zone is defined relative to the lockset 100. For example, an authentication zone for the lockset 100 may include a 90-degree angle from the lockset 100 facing outward that extends for 15 feet. In some embodiments, the authentication zone may be defined relative to a different reference point, such as the door 14 or a device that is external to the lockset 100.

In the example shown, the lockset 100 may receive credentials (step 308). For example, the lockset 100 may receive credentials from the mobile device 200. The credentials may be, for example, a signal, code, or alphanumeric string that is associated with an authorized user. An authorized user may be a user that is authorized to actuate the lockset 100. The credentials may be encrypted. In some embodiments, the credentials may be accompanied by or otherwise associated with a request, such as a request to lock, unlock, or arm the lockset 100.

In some embodiments, the lockset 100 may wirelessly receive the credentials over a network, such as BLE or UWB. In some embodiments, the lockset 100 may receive the credentials using a passive system. For example, the lockset 100 may emit signals that can be received by a user device. In response to receiving the signals from the lockset 100, the user device may automatically provide credentials to the lockset 100. As another example, the lockset 100 may use radio frequency angle-of-arrival or angle-of-departure techniques to detect that the mobile device 200 is nearby the lockset 100. Following such a determination, credentials may be automatically sent from the mobile device 200 to the lockset 100.

In some embodiments, the credentials may be biometric information of an authorized user, a recognized voice of the authorized user or other audio data, a positive facial recognition of the authorized user, or other data that may be used to verify that a user or a device is authorized to actuate the lockset 100. In some embodiments, after receiving the credentials, the lockset 100 may perform one or more of the steps 302-306. For example, after receiving the credentials, the lockset 100 may determine an authentication zone.

In the example shown, the lockset 100 may localize a source of the credentials (step 310). For example, if the credentials are sent by the mobile device 200, then the lockset 100 may determine a location of the mobile device 200. For example, the lockset 100 may determine a distance and direction of the mobile device 200 relative to the lockset 100. To do so, the lockset 100 may use radio frequency signals to communicate with the mobile device 200. For instance, the lockset 100 may use radio frequency angle-of-arrival or angle-of-departure techniques. As another example, the lockset 100 may receive a geolocation of the mobile device 200 from the server 18 or from the mobile device 200.

In some embodiments, the lockset 100 may determine a location of a device or user that is associated with the credentials but may not have sent the credentials. For example, a first user may send an actuation request to the lockset 100 via the server 18. The request may be associated with credentials. The request may indicate that the lockset 100 is to, for example, unlock if a second user is nearby the lockset 100. After receiving the request from the first user, the lockset 100 may then determine a location of the second user, and the lockset 100 may be actuated if it is determined that the second user, or a device associated with the second user, is in the authentication zone.

In the example shown, the lockset 100 may determine whether the source of the credentials is located in the authentication zone (step 312). For example, the lockset 100 may compare the determined location of the credentials source with the determined authentication zone. In response to determining that the source is within the location zone (e.g., taking the “YES” branch), the lockset 100 may proceed to actuate the lock. In response to determining that the source of the credentials is not in the authentication zone (step 316), the lockset 100 may not actuate the lockset.

In the example shown, the lockset 100 may actuate a locking mechanism (step 314) after determining that credential source is in the authentication zone. Depending on an instruction received by the lockset 100 or on a determined state of the lockset 100, actuating the locking mechanism may include moving the lockset 100 from a locked state to an unlocked state or from an unlocked state to a locked state. In some embodiments, prior to actuating the locking mechanism, the lockset 100 may perform a two-factor authentication by asking the user 12 or the mobile device 200 whether the user is attempting to actuate the lockset 100. To do so, the lockset 100 may directly send a message to the mobile device 200, or the server 18 may send a message to the mobile device 200.

In the example shown, the lockset 100 may not actuate a locking mechanism (step 316) after determining that the source of the credentials is not in the authentication zone. For example, the mobile device 200 may be located within a secured area to which the lockset 100 is attached. Because the mobile device 200 is within communication range of the lockset 100, credentials may be provided from the mobile device 200 to the lockset 100. However, the lockset 100 may determine that the mobile device is not located in the authentication zone, because the authentication zone may not include an inside of the secured area. As a result, the lockset 100 may not actuate a locking mechanism. In some embodiments, the lockset 100 may alert the user 12 that credentials are being received by the lockset 100. For example, the lockset 100 may send a message to the user 12 asking whether the user 12 is attempting to actuate the lock. In response to receiving a response that the user 12 is, in fact, trying to actuate the lock, then the electronic lockset 100 may, in some instances, actuate the lock even though the user 12 is not located in the authentication zone.

FIG. 9 is a flowchart of an example method 330 for determining an authentication zone of the lockset 100 based on one or more of a handing of the door 14 or a parameter of the door 14. Aspects of the method 330 may be used to perform the step 306 of FIG. 8 (determining an authentication zone). Although the method 330 is described as being performed by the lockset 100, one or more other components may perform aspects of the method 330.

In the example shown, the lockset 100 may receive instructions to determine an authentication zone (step 332). For example, the lockset 100 may receive instructions to determine an authentication zone following an installation of the lockset 100, following an instruction to reset a parameter of the lockset 100, following a reception of credentials, or in response to another event triggered by one or more of the lockset 100, the mobile device 200, or the server 18.

In the example shown, the lockset 100 may determine handing of the door 14 (step 334). For example, the lockset 100 may determine whether the door 14 is left-handed or right-handed. The way in which the door 14 swings may depend on the handing of the door 14. In some embodiments, the handing of the door 14 may be determined from a user input, from a determination of whether the lockset 100 is in a locked or unlocked state, or by moving the lockset 100 from a locked state to an unlocked state, or vice-versa. Example techniques for determining a handing of the door 14 are described in copending U.S. Provisional Ser. No. 63/634,794 , entitled “Electronic Lockset with Automatic Handing”, the disclosure of which is hereby incorporated by reference in its entirety.

In the example shown, the lockset 100 may determine parameters of the door 14 (step 336). For example, the lockset 100 may determine one or more of the length, width, or height of the door 14. As other examples, the lockset 100 may determine whether the door 14 is an in-swinging door or an out-swinging door, whether the door 14 is an interior door or exterior door, whether the door 14 is a sliding door a swinging door, a range of motion of the door, or one or more other characteristics of the door 14. In some embodiments, the lockset 100 may receive data related to the door from one or more of the mobile device 200 or the server 18. In some embodiments, the door parameters are specific to the door 14, whereas in other embodiments, one or more door parameters may be generally applicable to a category of doors (e.g., doors of model “X” have a length of 4 feet and a range of motion of 85 degrees).

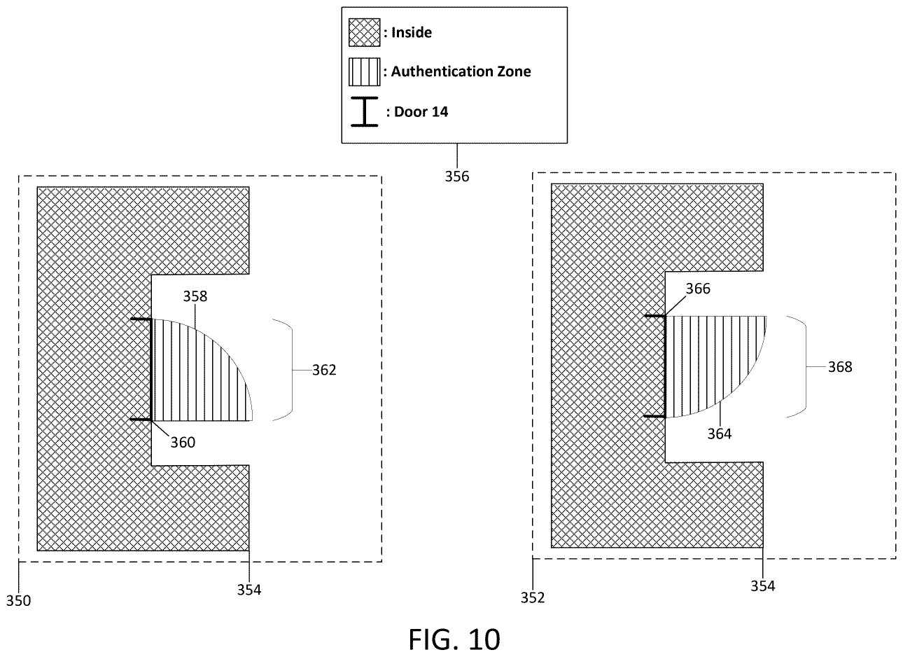

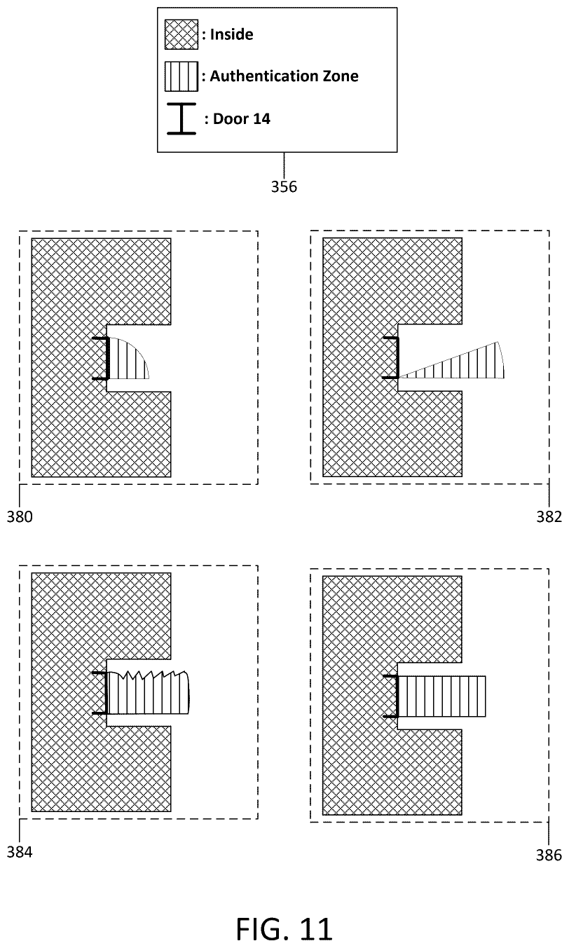

In the example shown, the lockset 100 may derive an authentication zone for the lockset 100 (step 338). To do so, the lockset 100 may use one or more of the door handing or door parameters. For example, based on a handing and a length of the door 14, the lockset 100 may determine an area in which the door 14 swings when opened. The lockset 100 may infer that there are no walls in the area in which the door swings. If the door 14 is an out-swinging door, then the lockset 100 may determine that the area in which the door swings is exterior to the secured area to which the lockset 100 is attached. As a result, the lockset 100 may include the area in which the doors swings as part of an authentication zone, as illustrated below in FIG. 10. Other examples for determining an authentication zone based on one or more of a door handing and a door parameter are likewise possible, as illustrated and described below in connection with FIG. 11.

In the example shown, the lockset 100 may be updated with the determined authentication zone (step 340). For example, data associated with the authentication zone may be written to the memory 146 of the processing unit 116. In some embodiments, data associated with the authentication zone may be stored at the server 18 in connection with an account associated with the lockset 100.

FIG. 10 illustrates examples 350-352 of determining an authentication zone for the lockset 100 based on a handing of the door 14 and on a length of the door 14. In each of the examples 350-352, a premises 354 is depicted that includes the door 14. Dimensions of the premises 354 in the examples 350-352 are illustrated for example purposes, and the dimensions of the premises 354 may vary. As indicated by the key 356, in the examples 350-352, an inside area of the premises 354 is denoted by intersecting diagonal lines. Furthermore, an authentication zone in each of the examples 350-352 is denoted by vertical lines, the door 14 is depicted with bolded lines, and the lockset 100 may be attached to the door 14.

In the example 350, the door 14 may be right-handed. The door 14 may be attached to the hinge 360 and the door 14 may swing outward. Furthermore, the door may have a length 362. Based on the length 362 and the determination that the door 14 is right-handed, the authentication zone 358 may be determined. For example, the authentication zone 358 may be a 90-degree arc with a radius that corresponds to the length of the door 14 and with a vertex located at the hinge 360. As shown, the authentication zone 358 may correspond with an outward swing of the door 14 and therefore may not include any walls of the premises 354.

In the example 352, the door 14 may be left-handed. The door 14 may be attached to the hinge 366 and the door 14 may swing outward. Furthermore, the door may have a length 368. Based on the length 368 and the determination that the door 14 is left-handed, the authentication zone 364 may be determined. For example, the authentication zone 364 may be a 90-degree arc with a radius that corresponds to the length of the door 14 and a vertex at the hinge 366. As shown, the authentication zone 364 may correspond with an outward swing of the door 14 and therefore may not include any walls of the premises 354. In both the examples 350-352, the authentication zones 358 and 364 may not include any area that is inside of the premises 354.

FIG. 11 illustrates further examples 380-386 in which the authentication zone for the lockset 100 may be determined using one or more of a handing or parameter of the door 14. In the examples 380-386, the door 14 may be right-handed, but similar techniques may be likewise applied to left-handed doors.

In the example 380, the authentication zone may be a 90-degree arc that has a radius corresponding to a length of the door 14, as described above in connection with FIG. 10. In the example 382, the authentication zone may be an arc with a smaller range than the arc of the example 380. Furthermore, in the example 382, the radius of the authentication zone may be longer than the length of the door 14. In the example 384, a plurality of combined arcs may be used to define the authentication zone 384. In the example 386, the authentication zone may include a rectangle that extends outward from the door 14. For example, the rectangle may have a width that corresponds to a length of the door, and the rectangle may have a length that extends indefinitely (e.g., as far as communication range of the lockset 100) or that extends a defined distance (e.g., fifteen feet).

FIG. 12 is a flowchart of an example method 400 for determining an authentication zone based in part on a user input. Aspects of the method 400 may be used to perform the step 306 of FIG. 8 (determining an authentication zone). Aspects of the method 400 are described as being performed by the mobile device 200. Specifically, in some instances, the electronic lock application 220 may be used to perform aspects of the method 400. However, other components than those described in connection with FIG. 12 may be used to perform operations of the method 400. For example, at least some aspects of the method 400 may be performed by the lockset 100 or the server 18.

In the example shown, the mobile device may receive instructions to determine an authentication zone (step 402). For example, the mobile device 200 may receive instructions form the lockset 100 or the server 18 to determine an authentication zone associated with the lockset 100. As another example, the electronic lock application 220 may provide instructions for determining an authentication zone of the lockset 100 as part of a process for installing the lockset 100.

In the example shown, the lockset 100 may display a user interface for determining an authentication zone (step 404). For example, the user interface may be displayed as part of the electronic lock application 220 or as part of another program installed on the mobile device 200, such as a web browser.

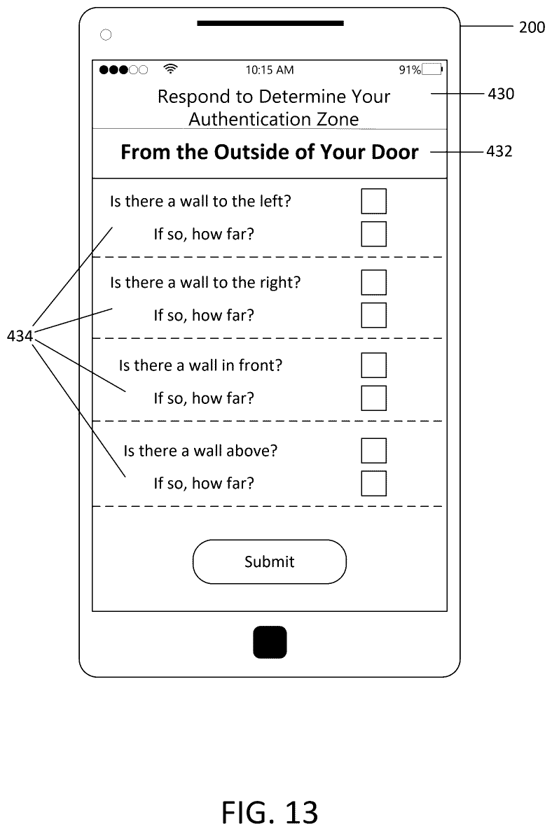

In the example shown, a mode for determining an authentication zone may be selected (step 405). For example, the user interface displayed for determining the authentication zone may include a plurality of options corresponding to modes for determining an authentication zone. As examples, a first mode may include using questions and answers (e.g., steps 406-408), a second mode may include displaying and receiving a selection of an example configuration (e.g., steps 410-412), and a third mode may include receiving another type of user input (e.g., step 414). In some embodiments, one or more of the lockset 100, the mobile device 200, or the electronic lock application 220 may select a mode for determining an authentication zone without a user input. In some embodiments, a plurality of modes may be used to determine or verify an authentication zone. In some embodiments, each of the modes may be associated with a user interface, such as the example user interfaces of FIGS. 13-15.

In a first mode (e.g., including steps 406-408), the mobile device 200 may display questions via a user interface (step 406). The questions may relate to the lockset 100, the door 14, a secured area to which the door 14 is attached, and other aspects of an area surrounding the lockset 100. Regarding the lockset 100, the questions may relate to a location of the lockset 100 or may relate to characteristics of the lockset 100. Regarding the door 14, the questions may relate to a size, type, handing, swing, or other characteristic of the door 14. Regarding the secured area, the questions may relate to characteristics of the secured area, such as a direction and distance of walls relative to the door 14 or the lockset 100.

In the example shown, the mobile device 200 may receive responses to the questions (step 408). For example, the user may input responses to the questions by using an input device of the mobile device 200. In some embodiments, when a user inputs a response to a question, a follow-up question may be asked. For example, if the user responds that there is a wall that extends outward on a right-hand side of the door 14, then a follow-up question related to the wall may be asked, such as a distance between the wall and the door 14.

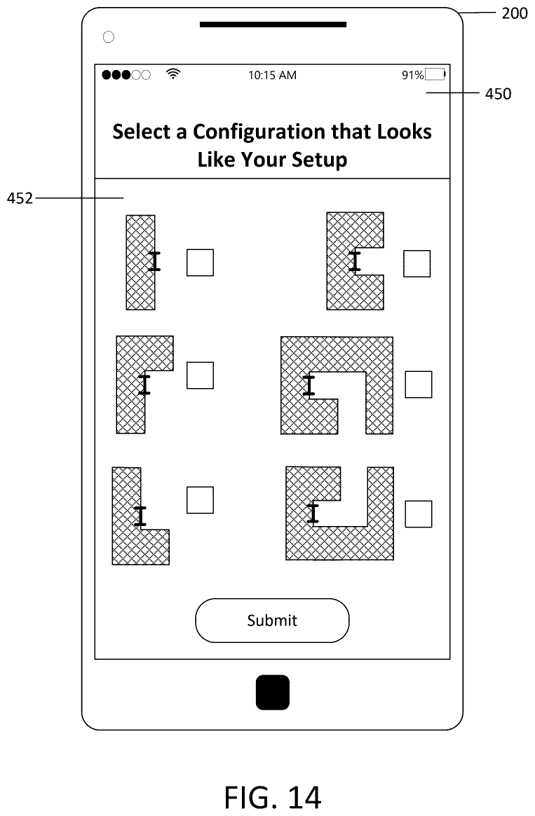

In a second mode (e.g., steps 410-412), the mobile device 200 may display example configurations (step 410). For example, the mobile device 200 may display one or more pictures that represent example configurations of a secured area to which the lockset 100 is attached, an example of which is illustrated below in connection with FIG. 14.

In the example shown, one of the example configurations may be selected (step 412). For example, the user 12 may select an example configuration that most resembles the configuration of a premises associated with the user. In some embodiments, the user 12 may select that none of the displayed example configurations looks like the premises associated with the user 12. In response, one or more additional example configurations may be displayed.

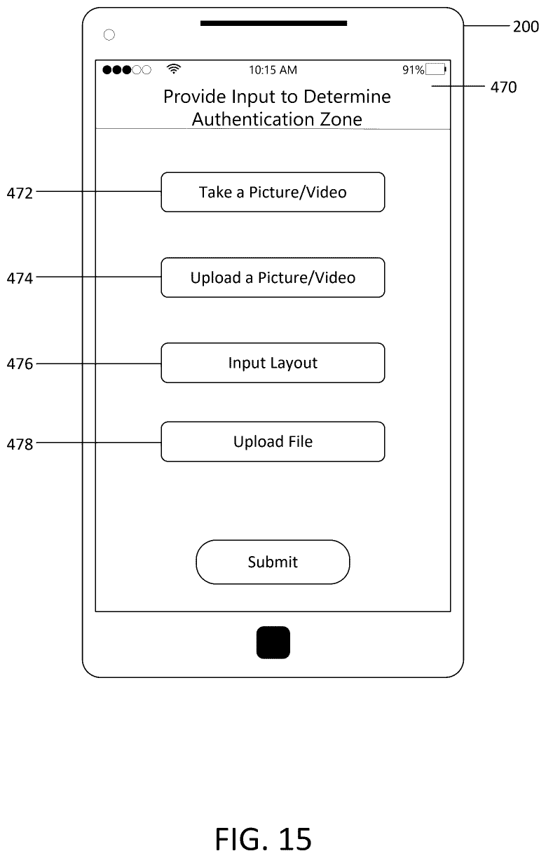

In a third mode (e.g., step 414), another type of user input may be received. For example, the user 12 may input one or more of an image, video, drawing, or other input that includes data related to a secured area or authentication zone associated with the lockset 100 or user 12. In some embodiments, the mobile device 200 displays a user interface via which the user 12 may input data related to the authentication zone. Example types of other input that may be received by the mobile device 200 are illustrated and described below in connection with FIG. 15.

In the example shown, the mobile device 200 may determine an authentication zone based on a user input (step 416).

For example, according to the first mode for determining an authentication zone, the mobile device 200 may determine an authentication zone based on responses to questions. For instance, the mobile device 200 may determine a location of one or more walls nearby the lockset 100 and thereby determine an authentication zone for the lockset 100.

According to the second mode of determining an authentication zone, the mobile device 200 may determine an authentication zone for the lockset 100 based on an example configuration selected by the user 12. For instance, if the user selects a configuration with a premises that includes an entryway with two outward-extending walls, then the mobile device 200 may define the authentication zone so as to exclude an inside portion of the outward-extending walls.

According to a third mode of determining an authentication zone, the mobile device 200 may determine the authentication zone based on the type of input received. For example, if an image or a video of the door 14 or the secured area is received, then the mobile device may apply an image processing application to detect locations in the image. For example, by analyzing the image, dimensions of a secured area to which the door 14 is attached may be determined. Other characteristics in the image may likewise be determined, such as a handing of the door 14 or other parameters of the door 14. In some embodiments, the image processing application may include a machine learning model trained to identify the location of a door and of a secured area to which the door is attached. As another example, if the input is a drawing that includes at least part of the secured area, then the authentication zone may be derived from the drawing.

In the example shown, the mobile device 200 may update the lockset 100 with the determined authentication zone (step 418). For example, the mobile device 200 may provide data for the authentication zone to the lockset 100 by using Bluetooth, Wi-Fi, or UWB. As another example, the mobile device 200 may provide data corresponding to the authentication zone to the server 18, which may then provide the data to the lockset 100. Once the lockset has received data for the authentication zone, the lockset 100 may write the data to the memory 146.

FIG. 13 illustrates an example user interface 430 of the mobile device 200 for determining an authentication zone associated with the lockset 100. The user interface 430 includes an instruction 432, and a plurality of question-answer fields 434. The instructions 432 may include information for the user 12 to follow when responding to the questions. In the example shown, the instructions 432 indicate that the user 12 is to answer from the outside of the door 14. The plurality of question-answer fields 434 include questions and input fields for responding to the questions. Based on the answers input into the question-answer fields 434, the mobile device 200 may determine an area relative to the lockset 100 that is external to the premises, and this area may be part of an authentication zone. Depending on the embodiments, there may be more, fewer, or different questions than those illustrated in the example of FIG. 13.

FIG. 14 illustrates an example user interface 450 of the mobile device 200 for determining an authentication zone associated with the lockset 100. The user interface 450 includes a region 452 with a plurality of example configurations of a secured area to which the lockset 100 may be attached. Furthermore, each of the example configurations may be selectable or may be associated with a selectable input field. In some embodiments, the user 12 may select a configuration that best matches a layout for which the user is configuring an authentication zone. Based at least in part on the selected layout, the mobile device 200 or the lockset 100 may determine an authentication zone.

FIG. 15 illustrates an example user interface 470 of the mobile device 200 for determining an authentication zone associated with the lockset 100. In the example of FIG. 15, the user interface 470 includes a plurality of options 472-478. The user 12 may, for example, select one of the options 472-478 and proceed to input data corresponding to the selected option.

For example, the user may take or upload a picture or video (options 472-474). For example, a camera (e.g., of the mobile device 200) may take a picture of an outside or inside of the door 14 and the surrounding area. An image processing application (e.g., on the mobile device 200 or the server 18) may analyze the image and identify objects in the images, including, for example, the lockset 100, the door 14, and walls of a premises to which the door 14 is attached. Furthermore, the image processing application may determine relative distances between objects recognized in the image (e.g., the image processing application may determine that, from the outside, 3 feet to the left of the door, a wall of a garage extends outward for 30 feet). In some embodiments, the image processing application includes a machine learning model that is trained to recognize one or more of a door and characteristics of a secured area to which the door is attached, such as walls. In some embodiments, a user may manually assist the image processing application to identify objects in the image and their locations relative to one another. Based on the analysis of the image or video, an authentication zone may be defined and provided to the lockset 100, or the lockset 100 may define the authentication zone based on the analysis of the image or video.

As another example, the user 12 may input a layout of the premises. For example, the user may input a drawing that includes dimensions of walls or other structures near the door 14. As another example, the user 12 may draw a layout of the premises. In some embodiments, the mobile device 200 may provide tools to assist the user 12 in drawing the layout of the premises, such as drag-and-drop components or manipulatable components that the user 12 may use to define a layout of a secured area near the door 14. As another example, the user 12 may upload another type of file that has information related to the premises to which the door 14 is attached or to an area surrounding the lockset 100.

FIG. 16 is a flowchart of an example method 490 for determining an authentication zone using one or more sensors. Aspects of the method 490 may be used to perform the step 306 of FIG. 8 (determining an authentication zone). Although described as being performed by the lockset 100, aspects of the method 490 may be performed by other components described herein.

In the example shown, the lockset 100 may receive instructions to determine an authentication zone (step 492), an example of which is described above in connection with the step 332 of FIG. 9.

In the example shown, the lockset 100 may select an object detection sensor (step 494). As described above in connection with FIG. 6, the lockset 100 may include one or more sensors for detecting objects external to the lockset 100. The one or more sensors may include, for example, a radio frequency sensor, an infrared sensor, or an ultrasound sensor. Additionally, in some embodiments, a camera may be used to detect external objects. In some embodiments, which sensing mechanism is selected to detect external objects my depend on which sensor is available. In some embodiments, a plurality of sensors may be used to ensure accurate detection of external objects.

In the example shown, the lockset 100 may use the selected sensor to determine a location of external objects (step 496). For example, the lockset 100 may determine an angle and distance of an object from the lockset 100. The external objects may be walls of the premises to which the lockset 100 is attached or of structures associated with the premises. In some embodiments, the external objects may be other objects that may define a secure location, such as fences, gates, or other objects. If one or more of a radio frequency sensor, an infrared sensor, or an ultrasound sensor are used, the lockset 100 may, in some embodiments, determine a distance and direction of an external object based on waves (e.g., radio waves, infrared waves, sound waves) that are reflected by the external object. If a camera is used, then an image processing application may be applied to an image captured of the external object, and the image processing application may recognize the external object in the image and determine a direction and distance of the external object from the lockset 100. In some embodiments, the image processing application may include a machine learning model that is trained to recognize walls or other objects that may be near a lockset 100.

In the example shown, the lockset 100 may determine an authentication zone based on locations of detected objects (step 498). For example, by detecting the objects, an area that is interior to a premises or exterior to a premises may be determined. Based on this determination, an authentication zone may be defined that includes only areas that are external to the premises.

In the example shown, the lockset 100 may update a lockset with the determined authentication zone (step 500), an example of which is described above in connection with the operation 340 of FIG. 9.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

1. An electronic lockset comprising:
a processor; and
a memory storing instructions that, when executed by the processor, cause the electronic lockset to:
determine a handing of a door of a secured area, wherein the electronic lockset is mounted to the door;
determine a length of the door;
based at least in part on the handing and the length of the door, determine an authentication zone, the authentication zone defining an area from which the electronic lockset is wirelessly actuatable;
receive a first credential from a mobile device;
determine that the first credential corresponds with an authorized credential;
determine that the mobile device is located in the authentication zone; and
in response to determining that the mobile device is located in the authentication zone, actuating a locking mechanism.

2. The electronic lockset of claim 1, wherein the instructions, when executed, cause the electronic lockset to:
receive a second credential from the mobile device;
determine that the second credential corresponds with the authorized credential;
determine that the mobile device is not located in the authentication zone; and
in response to determining that the mobile device is not located in the authentication zone, keeping the electronic lockset in a lock state.

3. The electronic lockset of claim 1, wherein the authentication zone is an arc that extends outward from the door; and
wherein a radius of the arc corresponds with the length of the door.

4. The electronic lockset of claim 3, wherein a vertex of the arc is determined based on the handing of the door.

5. The electronic lockset of claim 1, wherein the secured area is a building.

6. A set of one or more non-transitory computer readable media having instructions that, when executed by a set of one or more processors, cause the set to:
determine a handing of a door of a secured area;
determine a length of the door;
based at least in part on the handing and the length of the door, determine an authentication zone for an electronic lockset mounted to the door, the authentication zone defining an area from which the electronic lockset is wirelessly actuatable;
receive a first credential from a mobile device;
determine that the mobile device is located in the authentication zone; and
in response to determining that the mobile device is located in the authentication zone, actuating a locking mechanism.

7. The non-transitory computer readable medium of claim 6,
wherein the instructions, when executed by the at least one processor of the processor set, further cause the processor set to determine a location of a wall of the secured area, the location including a distance and direction of the wall relative to the electronic lockset; and
wherein determining the authentication zone for the electronic lockset is further based in part on the location of the wall.

8. The non-transitory computer readable medium of claim 7,
wherein determining the location of the wall comprises using a sensor embedded in the electronic lockset; and
wherein the sensor is one or more of a radio frequency sensor, an infrared sensor, or an ultrasound sensor.

9. The non-transitory computer readable medium of claim 7, wherein determining the location of the wall comprises using a camera to capture an image of the wall.

10. The non-transitory computer readable medium of claim 7, wherein determining the authentication zone is performed automatically without a user input.

11. The non-transitory computer readable medium of claim 6, wherein the instructions, when executed by the at least one processor of the processor set, further cause the processor set to:
receive a second credential from the mobile device;
determine that the second credential corresponds with the authorized credential;
determine that the mobile device is not located in the authentication zone; and
in response to determining that the mobile device is not located in the authentication zone, keeping the electronic lockset in a current lock state.

12. The non-transitory computer readable medium of claim 6, wherein the instructions, when executed by the at least one processor of the processor set, further cause the processor set to, in response to determining that the mobile device is not located in the authentication zone:
provide a message to the mobile device asking whether to actuate the electronic lockset;
receive, from the mobile device, a command to actuate the electronic lockset; and
in response to receiving the command, actuating the locking mechanism.

13. The non-transitory computer readable medium of claim 6, wherein the instructions, when executed by the at least one processor of the processor set, further cause the processor set to reconfigure the authentication zone using a user input received by the mobile device.

14. A system comprising:
an electronic lockset mounted to a door of a secured area; and
a mobile device;
wherein the electronic lockset is configured to:
determine a handing of the door;
determine a length of the door;
based at least in part on the handing and the length of the door, determine an authentication zone for the electronic lockset;
wirelessly receive a first credential from the mobile device;
determine that the first credential corresponds with an authorized credential;
determine that the mobile device is located in the authentication zone; and
in response to determining that the mobile device is located in the authentication zone, actuating a locking mechanism.

15. The system of claim 14, wherein the mobile device is configured to:
display a user interface;
receive, via the user interface, an input including data related to the secured area; and
based on the input, determine a second authentication zone for the electronic lockset.

16. The system of claim 15,
wherein the secured area is a building;
wherein the user interface displays a plurality of questions related to walls of the building; and
wherein the plurality of questions relate to a relative location of the walls of the building to the electronic lockset or the door.

17. The system of claim 15,
wherein the user interface displays a plurality of example configurations of the secured area; and
wherein the input is a selection of an example configuration of the plurality of example configurations.

18. The system of claim 15,
wherein the input is an image captured by a camera of the mobile device;
wherein the image depicts the door and at least part of the secured area;
wherein determining the second authentication zone for the electronic lockset based on the input includes analyzing the image with an image processing application; and
wherein the image processing application includes a machine learning model trained to recognize one or more of the door or a feature of the secured area.

19. The system of claim 15, wherein the input is a drawing of at least part of the secured area.

20. The system of claim 15, wherein the mobile device is configured to provide the second authentication zone to the electronic lockset.
